(19) United States
(12) Patent Application Publication
(10) Pub. No.: US 2023/0019807 A1
(43) Pub. Date: Jan. 19, 2023

(54) SECURE DISTRIBUTED RADIO ACCESS NETWORKS

(71) Applicant: AT&T Intellectual Property I, L.P., Atlanta, GA (US)

(72) Inventors: Joseph Soryal, Glendale, NY (US); Dylan Chamberlain Reid, Atlanta, GA (US)

(21) Appl. No.: 17/374,410

(22) Filed: Jul. 13, 2021

(51) Int. Cl. H04W 40/36; H04W 40/28; H04W 40/12; H04W 12/108; H04W 12/047; H04W 12/60; H04L 9/32

(52) U.S. Cl. CPC H04W 40/36; H04W 40/28; H04W 40/12; H04W 12/108; H04W 12/047; H04W 12/66; H04L 9/3236

(57) ABSTRACT

Secure, distributed radio access networks are enabled, e.g., to facilitate network resilience and security. For instance, a device can comprise a processor, and a memory that stores executable instructions that, when executed by the processor, facilitate performance of operations, comprising: in response an event being determined to have occurred that affects operation of a primary radio access network, activating an alternate radio access network via a group of mobile devices and re-routing communications from being communicated via a fixed location radio access network equipment of the primary radio access network to being communicated via the group of mobile devices of the alternate radio access network.

### TECHNICAL FIELD

The disclosed subject matter relates to radio access networks and network security, and more particularly, to alternate mesh radio access networks and associated security.

### BACKGROUND

Conventional radio access networks typically rely on cellular towers, poles, or microcells. Such towers, poles, or microcells, however, are vulnerable to denial of service (DoS) attacks, such as fake traffic and fake requests which can entail massive collision domains, as well as jamming or signal interference attacks. Quality of service (QoS) of a network can also be degraded absent actions by malicious entities, for instance, by fallen trees or a truck parked near a tower, microcell, or network node. Existing networks, and associated systems, do not adequately protect against network attacks or other causes of degradation of network QoS.

The above-described background relating to radio access networks and network security is merely intended to provide a contextual overview of some current issues and is not intended to be exhaustive. Other contextual information may become further apparent upon review of the following detailed description.

### BRIEF DESCRIPTION OF DRAWINGS

FIG. 1 is a block diagram of an exemplary system in accordance with one or more embodiments described herein.

FIG. 2 is a block diagram of an exemplary system in accordance with one or more embodiments described herein.

FIG. 3 is a block diagram of an exemplary system in accordance with one or more embodiments described herein.

FIG. 4 is a block diagram of an exemplary system in accordance with one or more embodiments described herein.

FIG. 5 is a block diagram of an exemplary system in accordance with one or more embodiments described herein.

FIG. 6 is a block diagram of an exemplary system in accordance with one or more embodiments described herein.

FIG. 7 is a block diagram of an exemplary system in accordance with one or more embodiments described herein.

FIG. 8 is a block diagram of an exemplary environment in accordance with one or more embodiments described herein.

FIG. 9 is a block diagram of an exemplary environment in accordance with one or more embodiments described herein.

FIG. 10 is a block diagram of an exemplary environment in accordance with one or more embodiments described herein.

FIG. 11 is a block diagram of an exemplary environment in accordance with one or more embodiments described herein.

FIG. 11 is a diagram of exemplary authentication in accordance with one or more embodiments described herein.

FIG. 12 is a flowchart for a method associated with an alternate radio access network and network security in accordance with one or more embodiments described herein.

FIG. 13 is a block flow diagram for a process associated with secure distributed radio access networks in accordance with one or more embodiments described herein.

FIG. 14 is a block flow diagram for a process associated with secure distributed radio access networks in accordance with one or more embodiments described herein.

FIG. 15 is a block flow diagram for a process associated with secure distributed radio access network security in accordance with one or more embodiments described herein.

FIG. 16 is an example, non-limiting computing environment in which one or more embodiments described herein can be implemented.

FIG. 17 is an example, non-limiting networking environment in which one or more embodiments described herein can be implemented.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding of the subject disclosure. It may be evident, however, that the subject disclosure may be practiced without these specific details. In other instances, well-known structures and devices are shown in block diagram form in order to facilitate describing the subject disclosure.

As alluded to above, there exists a need for improved radio access networks and associated radio access network security, and various embodiments are described herein to this end and/or other ends.

According to an embodiment, a device can comprise: a processor; and a memory that stores executable instructions that, when executed by the processor, facilitate performance of operations, comprising: identifying a group of mobile devices that comprise respective capabilities, collectively usable to establish an alternate radio access network as backup to a primary radio access network enabled via the fixed location radio access network equipment, wherein the fixed location radio access network equipment facilitates individual communicative connections to mobile devices of the group of mobile devices via the primary radio access network, and wherein the alternate radio access network comprises a peer-to-peer mesh network enabled via the group of mobile devices; and in response an event being determined to have occurred that affects operation of the primary radio access network, activating the alternate radio access network via the group of mobile devices and re-routing communications from being communicated via the fixed location radio access network equipment of the primary radio access network to being communicated via the group of mobile devices of the alternate radio access network.

In some embodiments, the operations can further comprise: determining a first connection quality associated with a first connection to the peer-to-peer mesh network from a first mobile device, of the group of mobile devices, entering a geographic region associated with the primary radio access network and associated with the alternate radio access network; and in response to the first connection quality being determined to be greater than a second connection quality associated with a second connection to the peer-to-peer mesh network from a second mobile device, of the group of mobile devices, located in the geographic region, replacing the second mobile device with the first mobile device in the alternate radio access network.

In various embodiments, each mobile device of the group of mobile devices can comprise a unique identifier of unique identifiers verified by the fixed location radio access network equipment using a blockchain communication network configured to authenticate the unique identifiers.

In an embodiment, the operations can further comprise: in response to verifying a mobile device of the mobile devices, updating trust data associated with the mobile device, wherein the trust data is representative of a probability that the mobile device is a potentially malicious mobile device, and wherein the updating results in a decrease in the probability.

It is noted that the operations can also further comprise: generating a data segment comprising padding bits representative of a three-dimensional shape, wherein the three-dimensional shape comprises a unique identifier of the data segment; and associating the data segment with a mobile device of the mobile devices.

In various embodiments, the three-dimensional shape can comprise a piece of a three-dimensional hologram puzzle, and an authentication can comprise the three-dimensional shape being determined to fit the three-dimensional hologram puzzle.

In an embodiment, the operations can further comprise: in response to determining that the three-dimensional shape fits the three-dimensional hologram puzzle, designating the data segment as an authorized data segment.

In one or more embodiments, activating the alternate radio access network can comprise activating the alternate radio access network via a communication sent to a manager mobile device, of the group of mobile devices, wherein the manager mobile device manages the peer-to-peer mesh network, and wherein, based on the communication, the manager mobile device can facilitate the activating of the peer-to-peer mesh network by sending further communications to other mobile devices of the group of mobile devices other than the manager mobile device.

In some embodiments, the operations can further comprise: determining that the event has occurred that has affected the operation of the primary radio access network, comprising obtaining information that the event has affected the operation of the primary radio access network by at least a threshold amount according to a defined network performance metric.

In another embodiment, a non-transitory machine-readable medium can comprise executable instructions that, when executed by a processor, facilitate performance of operations, comprising: determining a group of nodes that comprise respective capabilities, collectively usable to establish a substitute radio access network as a substitute for a main radio access network enabled via radio access network equipment, wherein the radio access network equipment facilitates individual communicative connections to the nodes of the group of nodes via the main radio access network, and wherein the substitute radio access network comprises a mesh network enabled via the group of nodes; and in response an incident being determined to have occurred that affects operation of the main radio access network, switching from using the main radio access network to using the substitute radio access network via the group of nodes, the switching comprising re-routing communications from being communicated via the radio access network equipment of the main radio access network to being communicated via the group of nodes of the substitute radio access network.

In some embodiments, the operations can further comprise: determining a first estimated amount of time that a node, of the group of nodes, is threshold likely to remain within a geographic region associated with the main radio access network and associated with the substitute radio access network; and in response to determining that a task, associated with the substitute radio access network, is achievable in the first estimated amount of time, assigning the task to the node.

In an embodiment, the task can comprise operating the node as an antenna. In another embodiment, the task can comprise operating the node as a transmitter. In an additional embodiment, the task can comprise operating the node as a signal processing filter. In a further embodiment, the task can comprise operating the node as a signal modulator. It is noted that the task can comprise recurring sub-tasks.

In one or more embodiments, the node can comprise a first node, and the operations can further comprise: determining a second estimated amount of time that a second node, of the group of nodes, is threshold likely to be located within the geographic region, wherein the second estimated amount of time terminates after the first estimated amount of time; and in response to determining that the task is achievable in the second estimated amount of time, reassigning the task from the first node to the second node.

In yet another embodiment, a method can comprise: generating, by a device comprising a processor, a data segment comprising padding bits and representative of a three-dimensional shape comprising a piece of a three-dimensional hologram puzzle, wherein the three-dimensional shape comprises a unique identifier of the data segment; associating, by the device, the data segment with a mobile device of a group of mobile devices collectively usable to establish a secondary radio access network as backup to a primary radio access network enabled via fixed location radio access network equipment; and in response to the three-dimensional shape being determined by the mobile device to fit the three-dimensional hologram puzzle, designating, by the device, the data segment as an authorized data segment.

In various embodiments, the mobile device can comprise a chamber comprising a projector and a sensor, and the mobile device can determine a quality of a match between shapes of the three-dimensional hologram puzzle according to a matching criterion by projecting the three-dimensional hologram puzzle within the chamber.

In an embodiment, the three-dimensional shape can comprise hashed data employable to reconstruct the piece of the three-dimensional hologram puzzle.

To the accomplishment of the foregoing and related ends, the disclosed subject matter, then, comprises one or more of the features hereinafter more fully described. The following description and the annexed drawings set forth in detail certain illustrative aspects of the subject matter. However, these aspects are indicative of but a few of the various ways in which the principles of the subject matter can be employed. Other aspects, advantages, and novel features of the disclosed subject matter will become apparent from the following detailed description when considered in conjunction with the provided drawings.

It should be appreciated that additional manifestations, configurations, implementations, protocols, etc. can be utilized in connection with the following components described herein or different/additional components as would be appreciated by one skilled in the art.

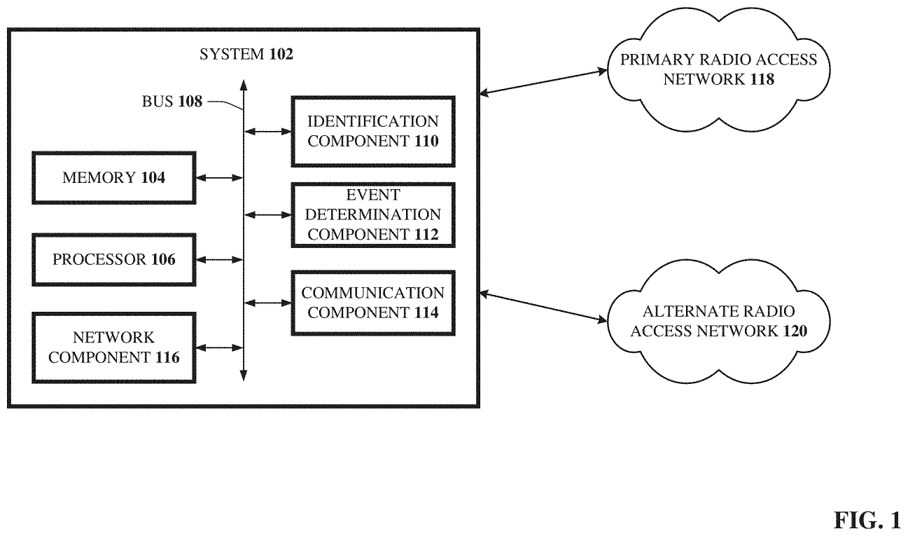

Turning now to FIG. 1, there is illustrated an example, non-limiting system 102 in accordance with one or more embodiments herein. System 102 can be configured to perform various operations relating to secure distributed radio access networks. The system 102 can comprise one or more of a variety of components, such as memory 104, processor 106, bus 108, identification component 110, event determination component 112, communication component 114, and/or network component 116.

In various embodiments, one or more of the memory 104, processor 106, bus 108, identification component 110, event determination component 112, communication component 114, and/or network component 116 can be communicatively or operably coupled (e.g., over a bus or wireless network) to one another to perform one or more functions of the system 102. In one or more embodiments, the system 102 can comprise fixed location radio access network equipment.

According to an embodiment, the identification component 110 can identify a group of mobile devices or nodes that comprise respective capabilities, collectively usable to establish an alternate radio access network 120 (e.g., a substitute radio access network) as backup to a primary radio access network 118 (e.g., a main radio access network) enabled via the system 102. Such capabilities can comprise hardware and/or software to enable participation and/or become registered with the alternate radio access network 120. It is noted that the alternate radio access network 120 can comprise a peer-to-peer mesh network (e.g., enabled via a group of mobile devices). Consequently, such capabilities can comprise hardware and/or software required to participate with and/or facilitate a peer-to-peer mesh network. In this regard, the identification component 110 can identity one or more mobile devices that can participate with, or facilitate, such a peer-to-peer mesh network, such as the alternate radio access network 120. It is noted that participation with the alternate radio access network 120 can be required or optional, depending on system 102 settings or network preferences. For instance, participation of a mobile device (not depicted in FIG. 1) with the alternate radio access network 120 can result in a reduction of corresponding data or network access costs. In other embodiments, participation with the alternate radio access network 120 can be required in order to gain access to the primary radio access network 118. In further embodiments, participation with the alternate radio access network 120 can yield faster data transmission speeds. It is noted that such mobile device(s) can comprise smartphones, laptops, tablets, smartwatches or other wearables, fitness devices, medical devices, cameras, connected vehicles such automobiles, boats, planes, motorcycles, scooters, etc., smart home devices, or other suitable Internet of Things (IoT) devices. Consequently, the identification component 110 can identify any such mobile devices that comprise respective capabilities collectively usable to establish the alternate radio access network 120 as backup to a primary radio access network 118 enabled via the system 102. In this regard, such mobile devices can facilitate a software defined radio (SDR) operating securely on the mobile device. Such a SDR can be configured on the mobile device using a mobile application for facilitating a respective microservice operating on the mobile device.

According to an embodiment, the event determination component 112 can determine whether an event (e.g., an incident) has occurred that affects operation of the primary radio access network 118 (e.g., main radio access network). Such an event can comprise a denial of service (DoS) attack, a jamming attack, or another event that results in a reduction in quality of service (QoS). Such a determination be made by comparing network activity (e.g., over the primary radio access network 118) to network activity thresholds. In other embodiments, artificial intelligence and/or machine learning can be leveraged in order to identify abnormal network events or network events that cause or are likely to cause a reduction in QoS. Such machine learning is later discussed in greater detail. In response to a determination by the event determination component 112 (or a machine learning (ML) component 704 as later discussed in greater detail) that such an event has occurred, the network component 116 can activate the alternate radio access network 120 via the group of mobile devices (not depicted in FIG. 1) and re-route communications from being communicated via the system 102 (e.g., using the communication component 114) of the primary radio access network 118 to being communicated via the group of mobile devices of the alternate radio access network 120. In this regard, the network component 116 can switch from using the main radio access network to using the substitute radio access network via a group nodes. Further in this regard, such switching can comprise re-routing communications from being communicated via the radio access network equipment of the main radio access network to being communicated via the group of nodes of the substitute radio access network.

In other embodiments, a mobile device of the group of mobile devices associated with the primary radio access network 118 can enable communications over the alternate radio access network 120 in response to total communication loss with, for instance, the system 102, primary radio access network 118, or a different network or network equipment. Further, such a mobile device (e.g., a manager mobile device as later discussed) can enable communications over the alternate radio access network 120 in response to an activation criterion being determined by the mobile device to be satisfied. Such an activation criterion can comprise a QoS criterion, or an event being determined (e.g., by the mobile device) to have occurred.

According to an embodiment, determining (e.g., by the event determination component 112) that the event has occurred that has affected the operation of the primary radio access network 118, can comprise obtaining information that the event has affected the operation of the primary radio access network 118 by at least a threshold amount according to a defined network performance metric (e.g., throughput, latency, packet loss, jitter, or another suitable performance metric).

According to an embodiment, activating the alternate radio access network 120 can comprise activating the alternate radio access network via a communication sent (e.g., by the communication component 114) to a manager mobile device, of the group of mobile devices, wherein the manager mobile device manages the peer-to-peer mesh network. In an embodiment, based on said communication, the manager mobile device can facilitate the activating of the peer-to-peer mesh network by sending further communications to other mobile devices of the group of mobile devices other than the manager mobile device.

It is noted that the system 102 can facilitate individual communicative connections to mobile devices of the group of mobile devices via the primary radio access network (e.g., via the communication component 114). According to an embodiment, the system 102 (e.g., communication component 114) can possess the hardware required to implement a variety of communication protocols (e.g., infrared (“IR”), shortwave transmission, near-field communication (“NFC”), Bluetooth, Wi-Fi, long-term evolution (“LTE”), 3G, 4G, 5G, global system for mobile communications (“GSM”), code-division multiple access (“CDMA”), satellite, visual cues, radio waves, etc.)

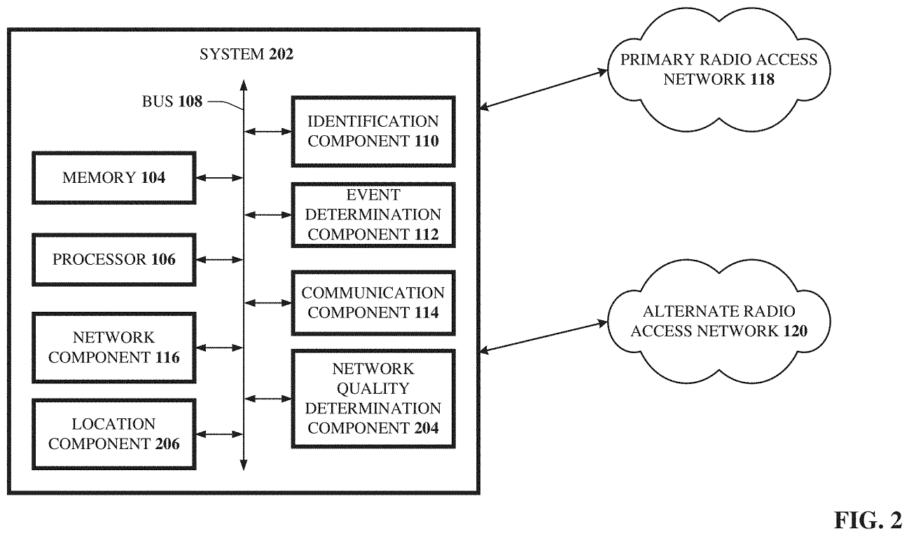

Turning now to FIG. 2, there is illustrated an example, non-limiting system 202 in accordance with one or more embodiments herein. System 202 can be configured to perform various operations relating to secure distributed radio access networks. The system 202 can be similar to system 102, and can comprise one or more of a variety of components, such as memory 104, processor 106, bus 108, identification component 110, event determination component 112, communication component 114, and/or network component 116. The system 202 can additionally comprise a network quality determination component 204 and/or a location component 206.

In various embodiments, one or more of the memory 104, processor 106, bus 108, identification component 110, event determination component 112, communication component 114, and/or network component 116, network quality determination component 204, and/or location component 206 can be communicatively or operably coupled (e.g., over a bus or wireless network) to one another to perform one or more functions of the system 202.

According to an embodiment, the network quality determination component 204 can determine a first connection quality associated with a first connection to the peer-to-peer mesh network (e.g., the alternate radio access network 120) from a first mobile device, of the group of mobile devices, entering a geographic region associated with the primary radio access network 118 and associated with the alternate radio access network 120. It is noted that the location component 206 can determine if/when the first mobile device enters said geographic region. The geographic can be defined according to network specifications or determined (e.g., using machine learning based on network availability).

According to an embodiment, the geographic region can comprise an area coverable by the primary radio access network 118 (e.g., under normal circumstances) and coverable by the alternate radio access network 120 (e.g., as a backup to the primary radio access network 118), such as in the event of a problem (e.g., reduction in QoS) over the primary radio access network 118.

In one or more embodiments, a connection quality (e.g., the first connection quality) can comprise a throughput, latency, packet loss, jitter, or other suitable connection quality metric. In this regard, the network quality determination component 204 can determine throughput, latency, packet loss, jitter, or other suitable connection quality metric for the first mobile device, a second mobile device, or any other device (e.g., IoT device) over the primary radio access network 118 or alternate radio access network 120.

In an embodiment, the network component 116 can, in response to the first connection quality being determined (e.g., by the network quality determination component 204) to be greater than a second connection quality associated with a second connection to the peer-to-peer mesh network from a second mobile device, of the group of mobile devices, located in the geographic region, replace the second mobile device with the first mobile device in the alternate radio access network. It is noted that replacing a mobile device herein can comprise transitioning one or more mobile devices to/from an active or inactive state in the peer-to-peer mesh network. In this regard, the second mobile device being replaced by the first mobile device can comprise transitioning the second mobile device from an active state to an inactive state (e.g., with respect to being a participant in the peer-to-peer mesh network) and transitioning the first mobile device from an inactive state to an active state. In other embodiments, replacing a mobile device can comprise removing said mobile device from the peer-to-peer mesh network and replacing it with a different mobile device.

In another embodiment, the location component 206 can determine a first estimated amount of time that a node (e.g., a device), of the group of nodes (e.g., a group of devices), is threshold likely to remain within a geographic region associated with the main radio access network (e.g., the primary radio access network 118) and associated with the substitute radio access network (e.g., the alternate radio access network 120). In this regard, in response to a determination (e.g., by the network component 116) that a task, associated with the substitute radio access network (e.g., the alternate radio access network 120) is achievable within the first amount of time, the network component 116 can assign the task to the node (e.g., the mobile device or another IoT device). According to various embodiments, the task can comprise one or more of operating the node as an antenna, transmitter, signal processing filter, signal modulator, or a different element of the alternate radio access network 120. It is noted that, in various embodiments, the task can comprise a recurring sub-task or a plurality of recurring sub-tasks. Such tasks or sub-tasks can be time-defined, such that a first mobile device can perform the task for a defined period of time (or a period of time during which the respective mobile devices is a node of an alternate radio access network, and can handoff the task to another mobile device of the alternate radio access network upon leaving the alternate radio access network or another device entering or remaining in the alternate radio access network that can perform the task better (e.g., faster, more volume, etc.). In another embodiment, the node can comprise a first node, and the location component 206 can determine a second estimated amount of time that a second node, of the group of nodes, is threshold likely to be located within the geographic region. It is noted that wherein the second estimated amount of time terminates after the first estimated amount of time. In an embodiment, in response to determining (by the network component 116) that the task is achievable in the second estimated amount of time, the network component 116 can reassign the task from the first node to the second node.

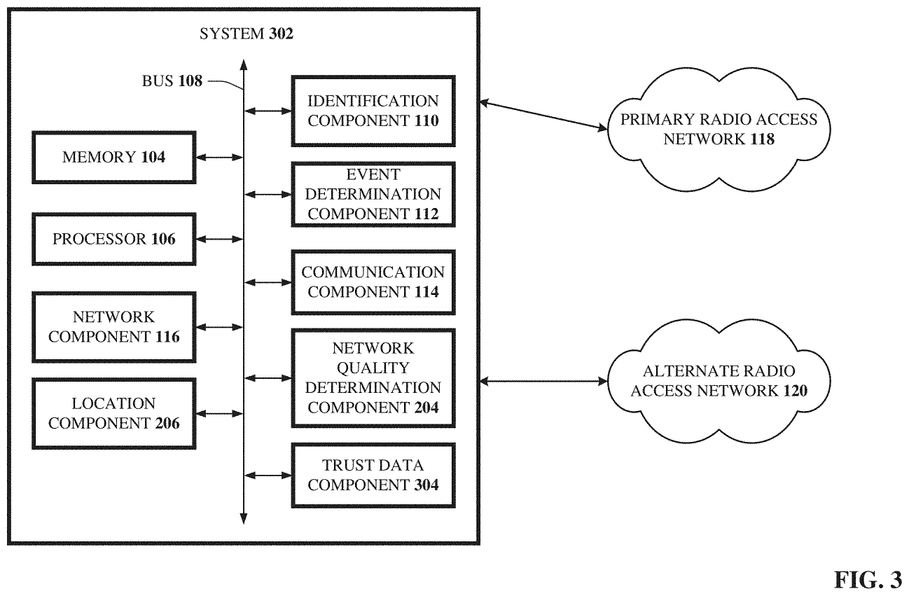

Turning now to FIG. 3, there is illustrated an example, non-limiting system 302 in accordance with one or more embodiments herein. System 302 can be configured to perform various operations relating to secure distributed radio access networks. The system 302 can be similar to system 202, and can comprise one or more of a variety of components, such as memory 104, processor 106, bus 108, identification component 110, event determination component 112, communication component 114, network component 116, network quality determination component 204, and/or location component 206. The system 202 can additionally comprise a trust data component 304.

In various embodiments, one or more of the memory 104, processor 106, bus 108, identification component 110, event determination component 112, communication component 114, and/or network component 116, network quality determination component 204, location component 206, and/or trust data component 304 can be communicatively or operably coupled (e.g., over a bus or wireless network) to one another to perform one or more functions of the system 302.

According to an embodiment, each mobile device of a group of mobile devices can comprise a unique identifier of unique identifiers verified by the system 302 (e.g., with a trust data component 304) using a blockchain communication network configured to authenticate the unique identifiers. In one or more embodiments, in response to verifying a mobile device of mobile devices, the trust data component 304 can update trust data associated with a respective mobile device. It is noted that such trust data can be representative of a probability that a given mobile device is a potentially malicious mobile device. It is further noted that in response to verifying the mobile device, respective trust data can be updated to note a decrease in a probability that the mobile device is a potentially malicious mobile device. Whether a device potentially comprises a malicious device can be dependent upon whether said mobile device threshold matches various criterion relating to potential device maliciousness. In other embodiments, machine learning can be leveraged (e.g., based on past device activity other than current device activity) in order to determine whether a current device is potentially malicious. In this regard, device activity can be stored in order to continuously improve determinations or predictions regarding a devices potential maliciousness.

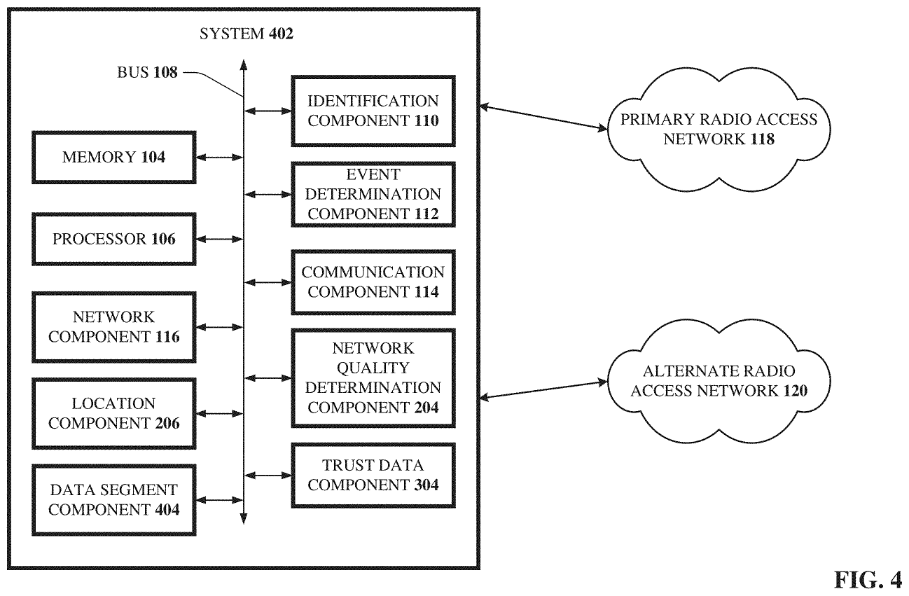

Turning now to FIG. 4, there is illustrated an example, non-limiting system 402 in accordance with one or more embodiments herein. System 402 can be configured to perform various operations relating to secure distributed radio access networks. The system 402 can be similar to system 302, and can comprise one or more of a variety of components, such as memory 104, processor 106, bus 108, identification component 110, event determination component 112, communication component 114, and/or network component 116, network quality determination component 204, location component 206, and/or trust data component 304. The system 402 can additionally comprise a data segment component 404.

In various embodiments, one or more of the memory 104, processor 106, bus 108, identification component 110, event determination component 112, communication component 114, and/or network component 116, network quality determination component 204, location component 206, trust data component 304, and/or data segment component 404 can be communicatively or operably coupled (e.g., over a bus or wireless network) to one another to perform one or more functions of the system 402.

According to an embodiment, the data segment component 404 can generate a data segment comprising padding bits representative of a three-dimensional shape. In various embodiments, the three-dimensional shape can comprise a unique identifier of the data segment. In one or more embodiments the data segment can be hashed. In this regard, the data segment component 404 can utilize a segment code and add padding bits in order to generate a hashed segment. It is noted that the data segment component 404 can further associate the data segment with a device (e.g., a mobile device) discussed herein. According to an embodiment, the generation of the data segment and hashing of the data segment can occur before data is transmitted (e.g., over the primary radio access network 118 and/or alternate radio access network 120) to ensure that mobile devices of the alternate radio access network 120 are authorized to participate in said alternate radio access network 120. In one or more embodiments, the three-dimensional shape comprises a piece of a three-dimensional hologram puzzle, and wherein an authentication comprises the three-dimensional shape being determined to fit the three-dimensional hologram puzzle.

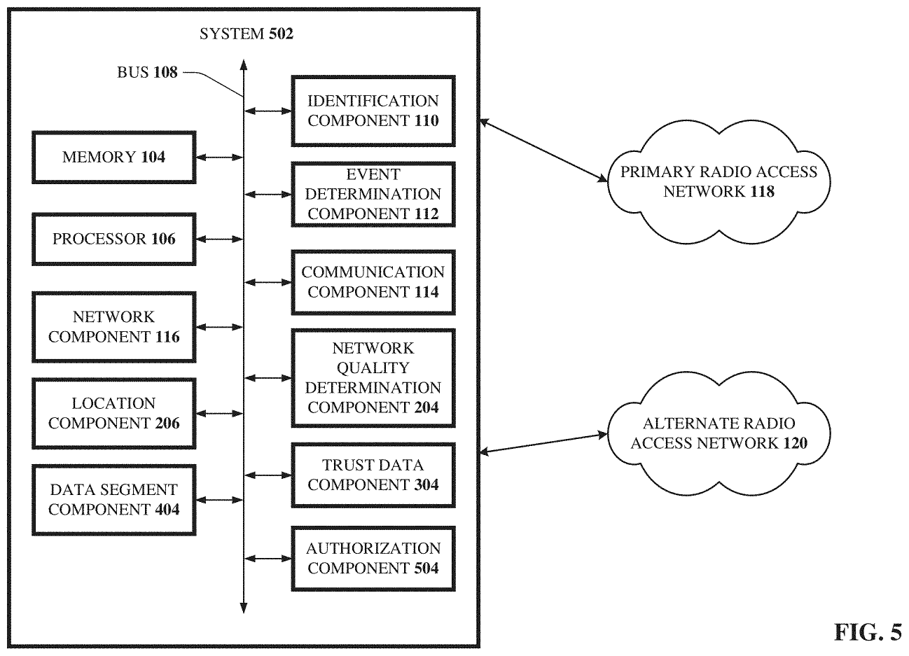

Turning now to FIG. 5, there is illustrated an example, non-limiting system 502 in accordance with one or more embodiments herein. System 502 can be configured to perform various operations relating to secure distributed radio access networks. The system 502 can be similar to system 402, and can comprise one or more of a variety of components, such as memory 104, processor 106, bus 108, identification component 110, event determination component 112, communication component 114, network component 116, network quality determination component 204, location component 206, trust data component 304, and/or data segment component 404. The system 502 can additionally comprise an authorization component 504.

In various embodiments, one or more of the memory 104, processor 106, bus 108, identification component 110, event determination component 112, communication component 114, and/or network component 116, network quality determination component 204, location component 206, trust data component 304, data segment component 404, and/or authorization component 504 can be communicatively or operably coupled (e.g., over a bus or wireless network) to one another to perform one or more functions of the system 502.

The authorization component 504 can, in response to determining that the three-dimensional shape fits the three-dimensional hologram puzzle, designate the data segment as an authorized data segment. It is noted that a three-dimensional shape fitting a three-dimensional hologram puzzle can comprise a first piece of the three-dimensional hologram puzzle (not depicted in FIG. 5) threshold fitting a second piece of the three-dimensional hologram puzzle. In this regard, a first piece can comprise a first segment (e.g., segment X), and a second piece can comprise a second segment (e.g., segment X+1).

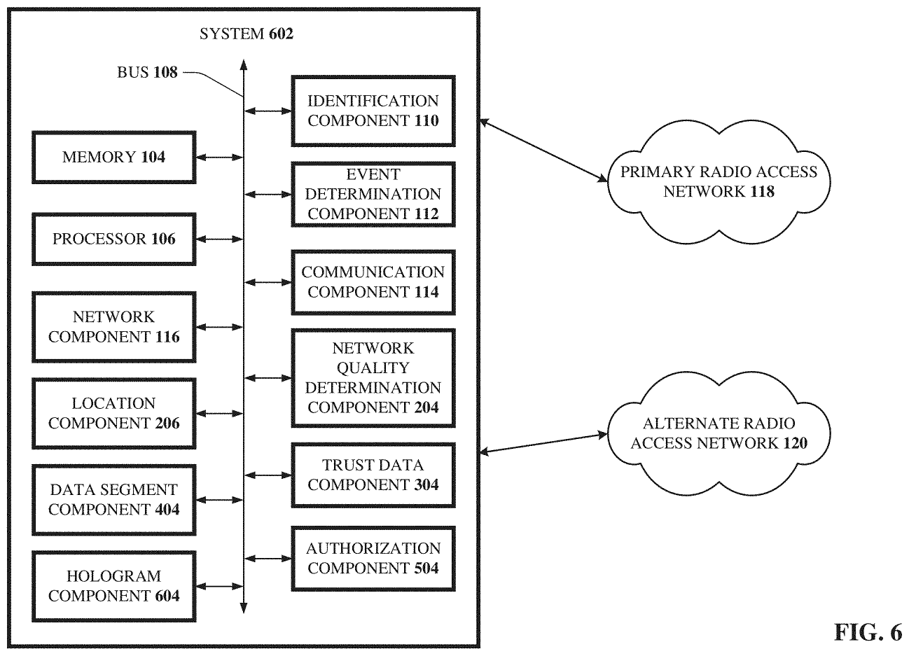

Turning now to FIG. 6, there is illustrated an example, non-limiting system 602 in accordance with one or more embodiments herein. System 602 can be configured to perform various operations relating to secure distributed radio access networks. The system 602 can be similar to system 502, and can comprise one or more of a variety of components, such as memory 104, processor 106, bus 108, identification component 110, event determination component 112, communication component 114, network component 116, network quality determination component 204, location component 206, trust data component 304, data segment component 404, and/or authorization component 504. The system 602 can additionally comprise a hologram component 604.

In various embodiments, one or more of the memory 104, processor 106, bus 108, identification component 110, event determination component 112, communication component 114, and/or network component 116, network quality determination component 204, location component 206, trust data component 304, data segment component 404, authorization component 504, and/or hologram component 604 can be communicatively or operably coupled (e.g., over a bus or wireless network) to one another to perform one or more functions of the system 602.

In an embodiment, the data segment component 404 can generate a data segment comprising padding bits and representative of a three-dimensional shape comprising a piece of a three-dimensional hologram puzzle. It is noted that the three-dimensional shape can comprise a unique identifier of the data segment. The data segment component 404 can associate the data segment with a mobile device of a group of mobile devices collectively usable to establish a secondary radio access network (e.g., alternate radio access network 120) as backup to a primary radio access network (e.g., primary radio access network 118) enabled via fixed location radio access network equipment (e.g., system 602). In an embodiment, in response to the three-dimensional shape being determined by the mobile device (e.g., using a hologram component 604) to fit the three-dimensional hologram puzzle, the data segment component 404 or authorization component 504 can designate the data segment as an authorized data segment.

In an embodiment, the system 602 can comprise the hologram component 604 therein. In other embodiment, a mobile device communicatively coupled to the system 602 (e.g., via the communication component 114) can comprise the hologram component 604 therein. In this regard, the hologram component 604 can comprise one or both of a micro hologram projector and a sensor. The micro hologram projector and the sensor can be located within a micro chamber of said mobile device. In an embodiment, the micro hologram projector can comprise dual projectors, each of which can project a piece of the three-dimensional hologram puzzle. In this regard, the sensor (e.g., a camera) can determine whether the two pieces of the three-dimensional hologram puzzle match or threshold match one another. In this regard, the mobile device can comprise a chamber comprising a projector(s) and a sensor(s). Further in this regard, the mobile device can determine a quality of a match between shapes of the three-dimensional hologram puzzle according to a matching criterion by projecting the three-dimensional hologram puzzle pieces within the chamber. It is noted that the three-dimensional shape can comprise hashed data employable to reconstruct the piece (or pieces) of the three-dimensional hologram puzzle. It is noted that, in order to determine matches, such sensors herein can measure light, thermal conductivity, electrical conductivity, emission, or other qualities of the hologram projections. In this regard, the hologram component 604 can comprise two adjacent projector nodes, one of which can project their own generated key (e.g., puzzle piece) and the other projecting the generated key of another device (e.g., for observation and matching/fitting quantification). One or both nodes can simulate a perfect fit/match and the sensor can observe or determine the associated parameters for use in comparison to the match between a first puzzle piece and a second puzzle piece (e.g., a received puzzle piece). The match between the actual puzzle pieces can be observed to determine any abnormalities. Using this observation method, the two holograms can be constructed inside a microcavity on a graphics processing unit (GPU), central processing unit (CPU), or motherboard of a respective device, and can observe the puzzle piece matches from all sides using a corresponding sensor to determine a percentage match between the two pieces. In an embodiment, each hologram puzzle piece can be inspected individually, or both hologram puzzle pieces can be collectively inspected as an assembly. Using a thermal conductivity matching method, because the holograms comprise laser beams, such beams can have higher temperatures than their surrounding space. The inspection here can be conducted via the heat surface (e.g., similar to infrared detection). In this regard, each hologram can be inspected individually or collectively. Using the electrical conductivity matching method, because the holograms are ionized particles which can be electrically conductive, the two hologram projectors, using associated sensors (e.g., of the hologram component 604) can measure the electrical flow between the two hologram pieces. If the two surfaces are not in complete contact (e.g., an imperfect match), resulting current will be lower than expected. In this regard, defined expected currents can be stored (e.g., in a memory 104) or can be determined (e.g., using machine learning as later discussed).

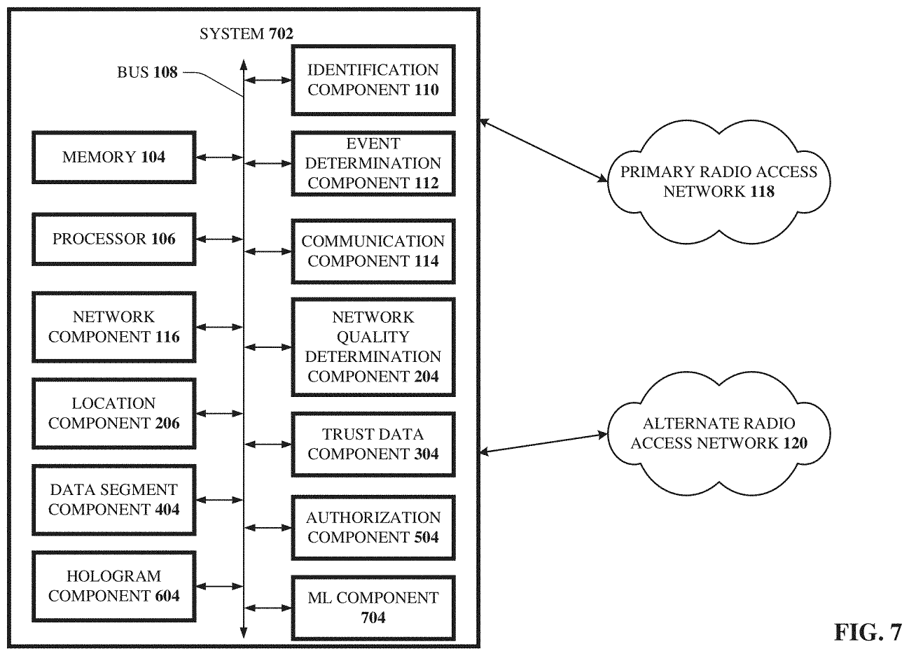

Turning now to FIG. 7, there is illustrated an example, non-limiting system 702 in accordance with one or more embodiments herein. System 702 can be configured to perform various operations relating to secure distributed radio access networks. The system 702 can be similar to system 602, and can comprise one or more of a variety of components, such as memory 104, processor 106, bus 108, identification component 110, event determination component 112, communication component 114, network component 116, network quality determination component 204, location component 206, trust data component 304, data segment component 404, authorization component 504, and/or hologram component 604. The system 702 can additionally comprise an ML component 704.

In various embodiments, one or more of the memory 104, processor 106, bus 108, identification component 110, event determination component 112, communication component 114, and/or network component 116, network quality determination component 204, location component 206, trust data component 304, data segment component 404, authorization component 504, hologram component 604, and/or

ML component 704 can be communicatively or operably coupled (e.g., over a bus or wireless network) to one another to perform one or more functions of the system 702.

The ML component 704 can, for instance, utilize machine learning/artificial intelligence to determine various thresholds herein based on previous activity of previous data. For instance, the ML component 704 can determine abnormal network events or network events that are likely to cause a reduction in QoS. According to an embodiment, in response to a determination by the ML component 704 that such an event has occurred, the network component 116 can activate the alternate radio access network 120 via the group of mobile devices and re-route communications from being communicated via the system 102 (e.g., using the communication component 114) of the primary radio access network 118 to being communicated via the group of mobile devices of the alternate radio access network 120. In another embodiment, the ML component 704 can determine geographic regions herein. In yet another embodiment, the ML component 704 can determine whether a device is potentially malicious. In this regard, device activity can be stored in order to continuously improve determinations or predictions regarding a devices potential maliciousness.

According to an embodiment, the system 702 can comprise the ML component 704. In another embodiments, respective mobile devices, communicatively coupled to the system 702, can additionally/alternatively comprise such an ML component 704. In this regard, such ML-enabled mobile devices can operate as surrogate mobile devices, or master mobile devices, and can distribute network resources (e.g., tasks herein) accordingly using artificial intelligence and machine learning techniques.

Various embodiments herein can employ artificial-intelligence or machine learning systems and techniques to facilitate learning user behavior, context-based scenarios, preferences, etc. in order to facilitate taking automated action with high degrees of confidence. Utility-based analysis can be utilized to factor benefit of taking an action against cost of taking an incorrect action. Probabilistic or statistical-based analyses can be employed in connection with the foregoing and/or the following.

It is noted that systems and/or associated controllers, servers, or machine learning components herein can comprise artificial intelligence component(s) which can employ an artificial intelligence (AI) model and/or machine learning (ML) or a machine learning model that can learn to perform the above or below described functions (e.g., via training using historical training data and/or feedback data).

In some embodiments, ML component 704 can comprise an AI and/or ML model that can be trained (e.g., via supervised and/or unsupervised techniques) to perform the above or below-described functions using historical training data comprising various context conditions that correspond to various augmented reality security operations. In this example, such an AI and/or ML model can further learn (e.g., via supervised and/or unsupervised techniques) to perform the above or below-described functions using training data comprising feedback data, where such feedback data can be collected and/or stored (e.g., in memory) by the ML component 704. In this example, such feedback data can comprise the various instructions described above/below that can be input, for instance, to a system herein, over time in response to observed/stored context-based information.

AI/ML components herein can initiate an operation(s) associated with a based on a defined level of confidence determined using information (e.g., feedback data). For example, based on learning to perform such functions described above using feedback data, performance information, and/or past performance information herein, an ML component 704 herein can initiate an operation associated with determining various thresholds herein.

In an embodiment, the ML component 704 can perform a utility-based analysis that factors cost of initiating the above-described operations versus benefit. In this embodiment, the ML component 704 can use one or more additional context conditions to determine various thresholds herein.

To facilitate the above-described functions, a ML component 704 herein can perform classifications, correlations, inferences, and/or expressions associated with principles of artificial intelligence. For instance, the ML component 704 can employ an automatic classification system and/or an automatic classification. In one example, the ML component 704 can employ a probabilistic and/or statistical-based analysis (e.g., factoring into the analysis utilities and costs) to learn and/or generate inferences. The ML component 704 can employ any suitable machine-learning based techniques, statistical-based techniques and/or probabilistic-based techniques. For example, the ML component 704 can employ expert systems, fuzzy logic, support vector machines (SVMs), Hidden Markov Models (HMMs), greedy search algorithms, rule-based systems, Bayesian models (e.g., Bayesian networks), neural networks, other non-linear training techniques, data fusion, utility-based analytical systems, systems employing Bayesian models, and/or the like. In another example, the ML component 704 can perform a set of machine-learning computations. For instance, the ML component 704 can perform a set of clustering machine learning computations, a set of logistic regression machine learning computations, a set of decision tree machine learning computations, a set of random forest machine learning computations, a set of regression tree machine learning computations, a set of least square machine learning computations, a set of instance-based machine learning computations, a set of regression machine learning computations, a set of support vector regression machine learning computations, a set of k-means machine learning computations, a set of spectral clustering machine learning computations, a set of rule learning machine learning computations, a set of Bayesian machine learning computations, a set of deep Boltzmann machine computations, a set of deep belief network computations, and/or a set of different machine learning computations.

According to an embodiment, some devices in a vicinity of a primary radio access network and/or alternate radio access network can be selected by a system herein (e.g., system 702) to be RAN Surrogates (RS) based on make, model, participation, device capability, device usage, or other respective mobile device (e.g., node or IoT) properties. It is noted that all RS's can be connected via a peer-to-peer mesh network. Most RS's move geographically, but the geographic area herein can be fixed, and can be covered by the original RAN (e.g., primary radio access network) footprint. RS's herein can comprise a Central Compute Function (CCF) and secondary functions (e.g., antennas or other tasks). The CCF can span multiple devices, but generally only one device is the manager mobile device. The CCF can be utilized for core management functions for the RAN.

Consequently, it is preferred for the manager mobile device to be the least-mobile (e.g., geographically moving) device so that it is the least likely to physically leave the geographic area associated with the alternate radio access network. The CCF can possess insight into other RANs in the area and their respective available capacities by communicating with said other RANs. The CCF area can depend on the quantity of eligible devices (e.g., nodes or IoTs) that can be enlisted for use with the alternate RAN. It is noted that the CCF can comprise a proxy that can be directly controlled by either RANs (the original RAN and the second nearest RAN, or alternate RAN, and respective systems discussed herein). Mobile devices (e.g., nodes or IoTs) are not aware if they comprise the CCF (e.g., for security purposes). Devices in a certain geographical area/region can be enlisted until all RAN resource functionalities (e.g., tasks) are achieved. Devices entering the geographical area can be enlisted, and devices leaving the area can give up their functionalities (e.g., tasks) to other existing or entering resources. According to an embodiment, participating devices can comprise an embedded process that can be continuously run in the background of said device. It is noted that artificial intelligence capable phones or devices can take open RAN capabilities that require AI algorithms.

According to an embodiment, each participant mobile device can comprise a unique code assigned at the time of participation or registration, which can be associated with to the respective mobile device or a physically unclonable function (PUF) that is registered at the time of participation, and can blockchained to ensure no cloning occurs. Each device can be assigned a trust level (e.g., from past experience such as actual resource announcements, validity of places that actually visited and registered on cell towers, etc.) For example, a new device can begin (e.g., upon registration) with a low trust-level, but the trust level can increase with more accurate and non-malicious participations. Once a participant enters the geographical area, any active participant can authenticate this newly entering node (e.g., via contacting the CCF which can contact a functionating RAN). Once the newly entering device is authenticated, the CCF can query the device for available resources and potential time in the area (e.g., direction, speed, historical data, home or office of the user, location user will stay for several hours, etc.). In this regard, historical behavior can be embedded in participating device processes. The CCF can determine which functions (e.g., tasks) are needed for the alternate RAN and which other devices are leaving the alternate RAN, and can utilize new device(s) to replace and supplement needed tasks.

Handing off of tasks can comprise some overlapping time between the incoming and outgoing devices, so that no interruption to active processes occur. Handoffs herein can be managed by the CCF devices or systems herein (e.g., system 704). It is noted that the manager mobile device or node can manage the handoff process within the CCF area.

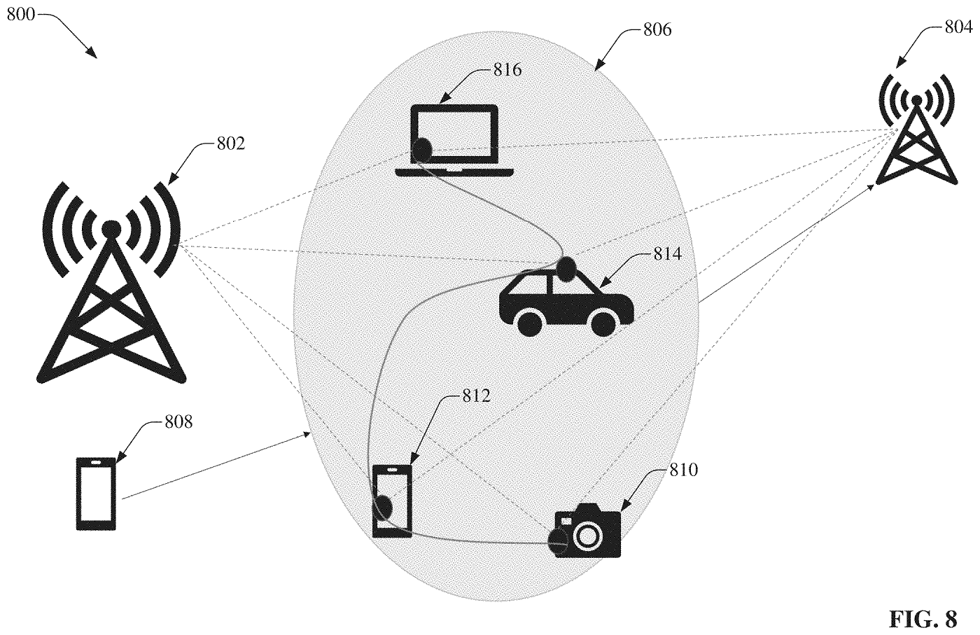

FIG. 8 depicts an exemplary environment 800 in accordance with one or more embodiments described herein. Environment 800 can comprise a RAN 802, RAN 804, alternate RAN 806, mobile device 808, IoT device (e.g., camera) 810, mobile device 812, vehicle 814, and laptop 816. In an embodiment, the RAN 802 and/or RAN 804 can both serve IoT device 810, mobile device 812, vehicle 814, and laptop 816. Mobile device 808, however, can be located outside a coverage area of both the RAN 802 and RAN 804. Mobile device 808, however, can connect to the alternate RAN 806. It is noted that the alternate RAN 806 can be similar to the alternate radio access network 120, and RANs 802 and 804 can each be similar to the primary radio access network 118. In an embodiment, IoT device 810, mobile device 812, vehicle 814, and laptop 816 can collectively facilitate the alternate RAN 806 such that the mobile device 808 can connect to the alternate RAN 806 rather than a RAN 802 or RAN 804. It is noted that the mobile device 808 can be authenticated to use the alternate RAN 806 using hologram puzzle matching and/or blockchain authentication as described herein. Further, in response to something being wrong at RAN 802, communication can continue via the alternate RAN 806 which can ultimately connect to the RAN 804, and still provide global communication access for the mobile device 808. In one or more embodiments, the mobile device 812 (or a different device, vehicle, IoT, etc.) can comprise a manager mobile device.

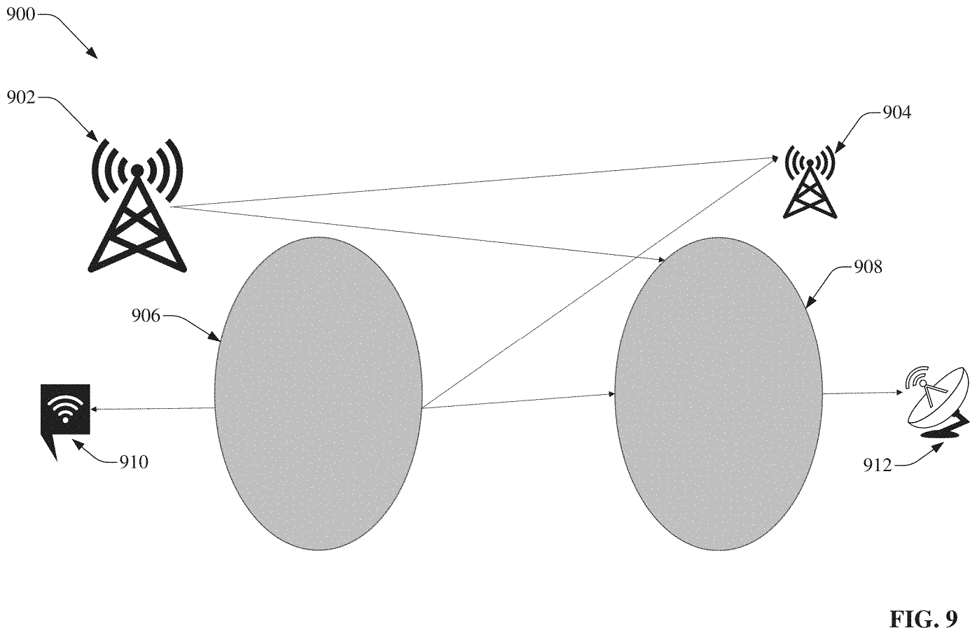

FIG. 9 depicts an exemplary environment 900 in accordance with one or more embodiments described herein. Environment 900 can comprise a RAN 902, RAN 904, alternate RAN 906, alternate RAN 908, Wi-Fi connection 910, and satellite connection 912. In this regard, various alternate RANs can be generated and can leverage a variety of sources for connection to a global network. For instance, mobile devices of the alternate RAN 906 or alternate RAN 908 can communicate with RANs 902 or 904. Additionally/alternatively, mobile devices of the alternate RAN 906 or alternate RAN 908 can communicate with Wi-Fi connection 910, and/or satellite connection 912 for connection to a global network. The foregoing can, for instance, be leveraged with fifth generation (5G) or sixth generation (6G) communication or networks in order to avoid a DoS attack and prevent a whole network in an area from being blocked. In this regard, a RAN (e.g., RAN 902) can be suspended and communication in its geographic area can instead be facilitated via an alternate RAN (e.g., alternate RAN 906).

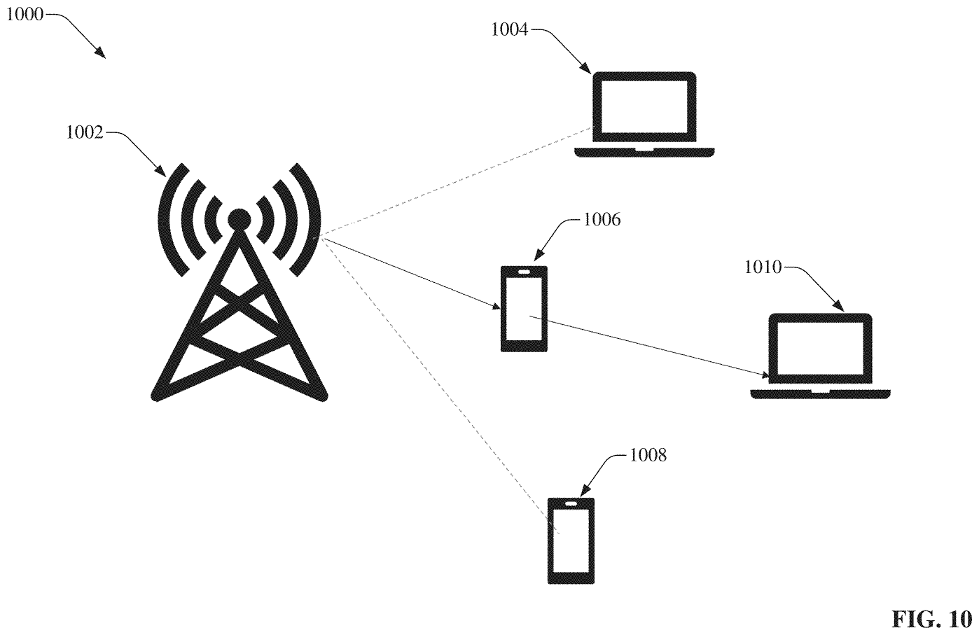

FIG. 10 depicts an exemplary environment 1000 in accordance with one or more embodiments described herein. Environment 1000 can comprise a RAN 1002, IoT device 1004, IoT device 1006, IoT device 1008, and IoT device 1010. IoT devices 1004, 1006, and/or 1008 can be connected to the RAN 1002 for data communication. However, IoT device 1010 is not connected to the RAN 1002, and therefore must connected to at least one of IoT device 1004, 1006, or 1008. In this regard, IoT device 1006 can comprise an active node, and IoT devices 1004 and 1008 can comprise inactive or standby nodes, ready to switch with the IoT device 1006 depending on a variety of factors, such as respective connection quality and/or location with respect to a geographic region comprising an alternate RAN associated with IoT devices 1004, 1006, and/or 1008. It is noted that inactive nodes can be leveraged to verify activities of active nodes. In this regard, inactive nodes can comprise the same encryption keys, credentials, etc. as active nodes and can monitor input/output of the active nodes. If inputs/outputs of the active nodes match the inactive nodes (e.g., threshold match according to a defined input/output matching criterion), then the respective task can be verified. However, inputs/outputs of active nodes to not threshold match those of inactive nodes (e.g., at least 50% of the inactive nodes do not agree with the active node), then the active node can be removed or replaced with a previously inactive node and the active node. In this regard, the active node that was replaced can be removed or blocked from utilizing the respective alternate radio access network.

In an embodiment, the RAN (e.g., the RAN that created the surrogate system, or another RAN in the vicinity if the original one is unavailable for any reason such as maintenance, DoS attack, etc.), can duplicate its functionalities of each segment and deploy them to different hosts (e.g., devices or node). In this regard, generally one IoT device can be active, and others can be in a standby mode. Typically, host devices (e.g., IoT devices) do not know which segment they respectively host, or whether it is active or in a standby mode for use in an alternate radio access network, because the non-active IoT devices can appear busy by consuming some CPU and memory, and can facilitate fake data processing, transmissions, or verification/validation of active IoT devices/nodes. All segments from the same type (e.g., whether active or non-active/standby) can comprise the same credentials with a unique code for tracking purposes but can access and process the same data. In this regard, all segments from the same type (e.g., whether active or non-active/standby) can be directly connected or via the CCF. Non-active segments, while not active, can process the same data/requests as the active segments, and can monitor the output of the active IoT and compare to their calculations and data that would have been transmitted had this segment been active with the actual active IoT. If a defined quantity or percentage of non-active IoTs/segments report that an active IoT is misbehaving (e.g., more than 50% of non-active IoTs report data discrepancies with an active IoT), then the RAN 1002 can be notified by a non-active IoT in order to remove active IoT from the mesh network. It is noted that the non-active IoT can monitor the active IoT for data transmission and processing times. These non-active IoTs can be of the same type and can decrypt the same segment types.

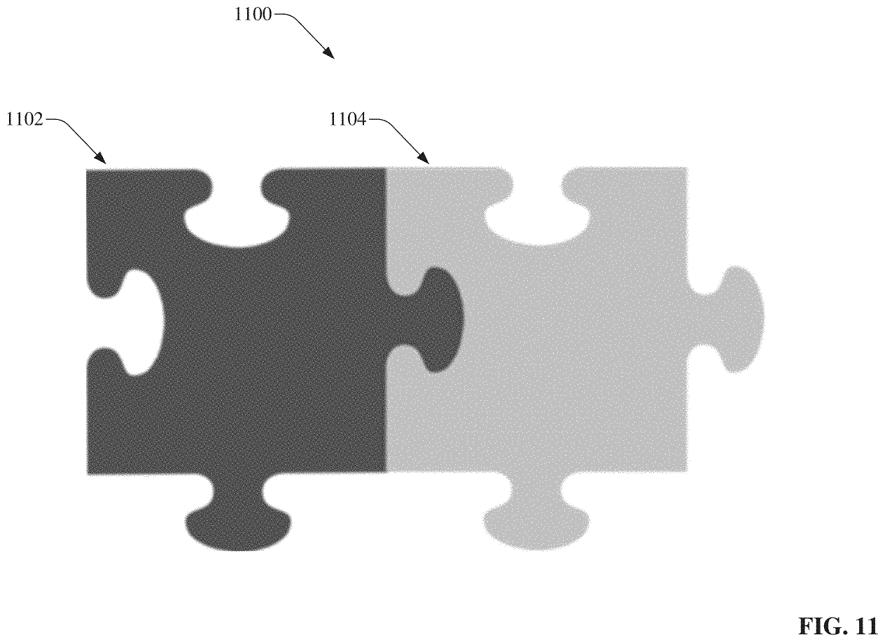

FIG. 11 illustrates three-dimensional hologram matching in accordance with various embodiments described herein. In this regard, piece 1102 (e.g., segment X) can threshold match piece 1104 (e.g., segment X+1). It is noted that such three-dimensional hologram projections and corresponding matching evaluations can occur within a chamber of an associated mobile device. It is noted that such pieces or segments can comprise formulas representative of such geometric shapes (e.g., three-dimensional puzzle pieces). According to an example, when piece 1102 needs to connect piece 1104 (e.g., to perform an authentication), piece 1102 can be presented with the piece 1104 segment X+1 and observation for a perfect match or threshold match can be conducted. The respective mobile device can segment can construct the hologram of the three-dimensional shape to determine if there exists proper fitment between the pieces by trying different sides of each piece. As a second layer of authentication, only authorized devices can possess a key to construct the hologram. It is noted that a separate key can be utilized for a hologram constructor inside the mobile devices. Each three-dimensional puzzle piece can possess multiple sides (e.g., one for each interface with puzzle piece of another device or IoT). An associated system or RAN can generate unique, three-dimensional, authentication keys (e.g., represented by mathematical formulas). It is noted that puzzle pieces can be changed with every transaction.

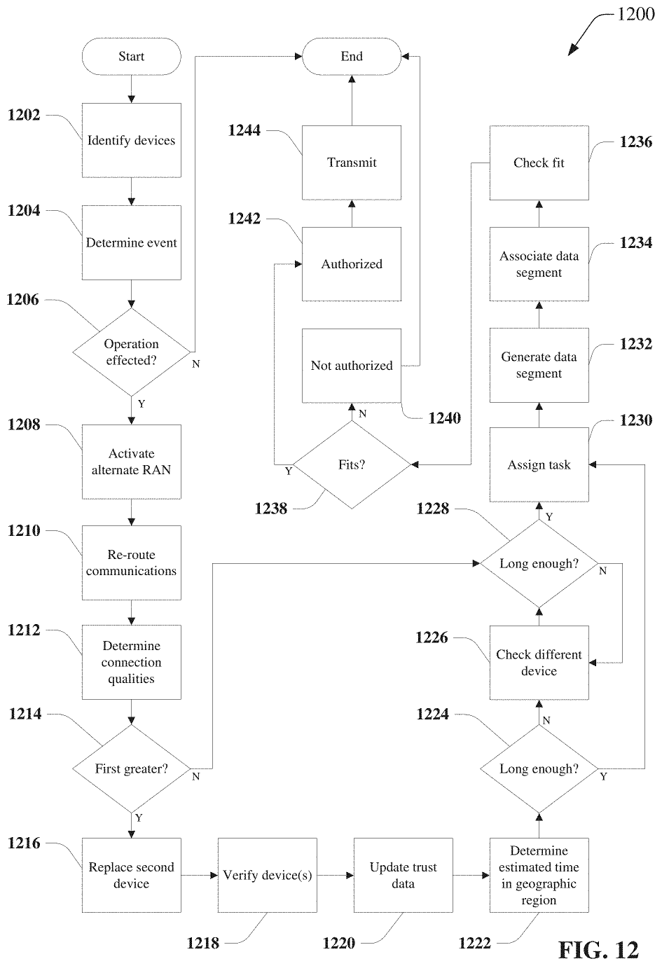

Turning now to FIG. 12, there is illustrated a flow chart of a process 1200 relating to secure distributed radio access networks in accordance with one or more embodiments described herein. At 1202, an identification component 110 can identify a group of mobile devices or nodes that comprise respective capabilities, collectively usable to establish an alternate radio access network 120 (e.g., a substitute radio access network) as backup to a primary radio access network 118 (e.g., a main radio access network) enabled via a system herein. At 1204, the event determination component 112 can determine whether an event (e.g., an incident) has occurred that affects operation of the primary radio access network 118 (e.g., main radio access network). If at 1206, an operation is determined to affect operation of the primary radio access network (Y at 1206), the process can proceed to 1208. Otherwise, if the operation is determined not to affect operation of the primary radio access network (N at 1206), the process can end. At 1208, the network component 116 can activate the alternate radio access network 120 via a group of mobile devices. At 1210, the network component 116 can re-route communications from being communicated via the primary radio access network 118 to being communicated via the group of nodes of the alternate radio access network 120. At 1212, the network quality determination component 204 can determine a first connection quality associated with a first connection to the peer-to-peer mesh network (e.g., the alternate radio access network 120) from a first mobile device, of the group of mobile devices, entering a geographic region associated with the primary radio access network 118 and associated with the alternate radio access network 120. At 1214, if the first connection quality is greater than a second connection quality associated with a second connection to the peer-to-peer mesh network from a second mobile device of the group of mobile devices, located in the geographic region (Y at 1214), the process can proceed to 1216. If at 1214, the first connection quality is not greater than the second connection quality (N at 1214), the process can proceed to 1228. At 1216, the first mobile device can replace the second mobile device in the alternate radio access network. At 1218, the trust data component 304 can verify the first mobile device or the second mobile device (or a different mobile device). At 1220, in response to verifying a mobile device of mobile devices, the trust data component 304 can update trust data associated with a respective mobile device. At 1222, the location component 206 can determine an estimated amount of time that a node (e.g., a device) is threshold likely to remain within a geographic region associated with the main radio access network (e.g., the primary radio access network 118) and/or associated with the substitute radio access network (e.g., the alternate radio access network 120). At 1224, if the device is threshold likely to remain within the geographic region long enough to perform a task (Y at 1224), the network component 116 can assign the task to the device or node. If the device is not threshold likely to remain within the geographic region long enough to perform the task (N at 1224), the process 1200 can proceed to 1226, at which a different device or node is duration checked (and compared to the time needed to complete the task). If at 1228, the duration is long enough (Y at 1228), the process 1200 can proceed to 1230 at which the task is assigned to the respective device or node. If at 1228, the duration is not long enough (N at 1228), the process 1200 can return to 1226 to check another device. At 1232, the data segment component 404 can generate a data segment comprising padding bits representative of a three-dimensional shape. At 1234, the data segment component 404 can associate the data segment with the respective device performing the task. At 1236, a three-dimensional hologram puzzle piece can be checked for fitment between the respective mobile device and the next mobile device or node to which the mobile device seeks to communicate with. If at 1238, the puzzle pieces fit (e.g., threshold match) (Y at 1238), the process can proceed to 1242. If at 1238, the puzzle pieces do not fit or threshold match (N at 1238), the process can proceed to 1240. In this regard, at 1240, communication is not authorized and the respective mobile device with the non-matching piece can be suspended or removed from a respective alternate radio access network 120. At 1242, communication is authorized, and the respective mobile device can facilitate communication over the respective alternate radio access network 120. In this regard, data can be transmitted at 1244.

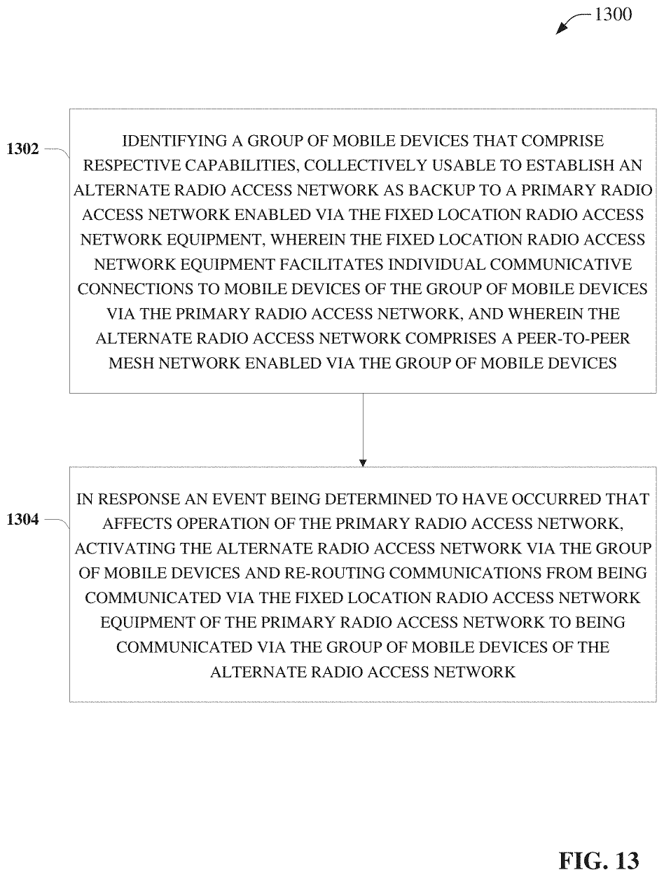

FIG. 13 illustrates a block flow diagram for a process 1300 associated with secure distributed radio access networks in accordance with one or more embodiments described herein. At 1302, the process 1300 can comprise: identifying a group of mobile devices that comprise respective capabilities, collectively usable to establish an alternate radio access network as backup to a primary radio access network enabled via the fixed location radio access network equipment, wherein the fixed location radio access network equipment facilitates individual communicative connections to mobile devices of the group of mobile devices via the primary radio access network, and wherein the alternate radio access network comprises a peer-to-peer mesh network enabled via the group of mobile devices. At 1304, the process 1300 can comprise: in response an event being determined to have occurred that affects operation of the primary radio access network, activating the alternate radio access network via the group of mobile devices and re-routing communications from being communicated via the fixed location radio access network equipment of the primary radio access network to being communicated via the group of mobile devices of the alternate radio access network.

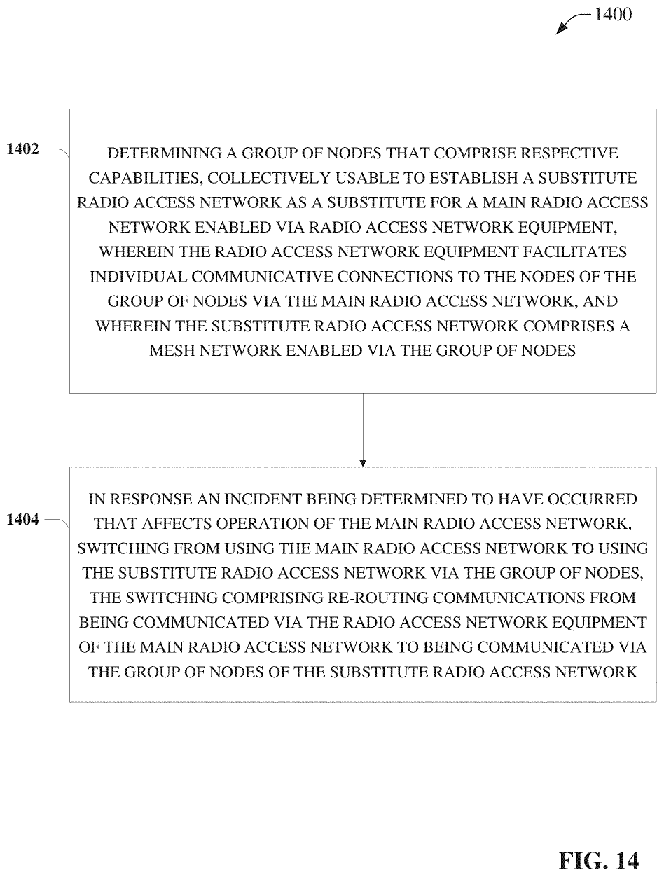

FIG. 14 illustrates a block flow diagram for a process 1400 associated with secure distributed radio access networks in accordance with one or more embodiments described herein. At 1402, the process 1400 can comprise: determining a group of nodes that comprise respective capabilities, collectively usable to establish a substitute radio access network as a substitute for a main radio access network enabled via radio access network equipment, wherein the radio access network equipment facilitates individual communicative connections to the nodes of the group of nodes via the main radio access network, and wherein the substitute radio access network comprises a mesh network enabled via the group of nodes. At 1404, the process 1400 can comprise: in response an incident being determined to have occurred that affects operation of the main radio access network, switching from using the main radio access network to using the substitute radio access network via the group of nodes, the switching comprising re-routing communications from being communicated via the radio access network equipment of the main radio access network to being communicated via the group of nodes of the substitute radio access network.

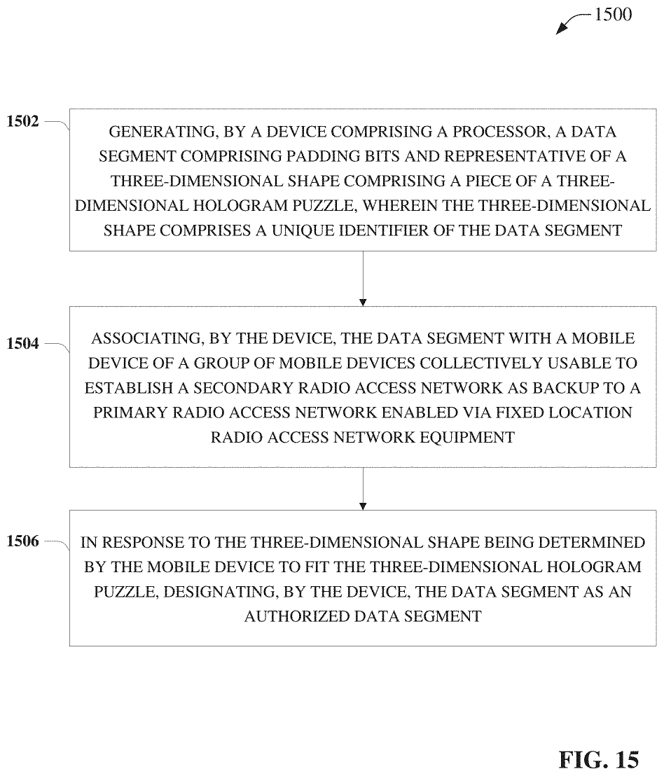

FIG. 15 illustrates a block flow diagram for a process 1500 associated with secure distributed radio access networks in accordance with one or more embodiments described herein. At 1502, the process 1500 can comprise: generating, by a device comprising a processor, a data segment comprising padding bits and representative of a three-dimensional shape comprising a piece of a three-dimensional hologram puzzle, wherein the three-dimensional shape comprises a unique identifier of the data segment. At 1504, the process 1500 can comprise: associating, by the device, the data segment with a mobile device of a group of mobile devices collectively usable to establish a secondary radio access network as backup to a primary radio access network enabled via fixed location radio access network equipment. At 1506, the process 1500 can comprise: in response to the three-dimensional shape being determined by the mobile device to fit the three-dimensional hologram puzzle, designating, by the device, the data segment as an authorized data segment.

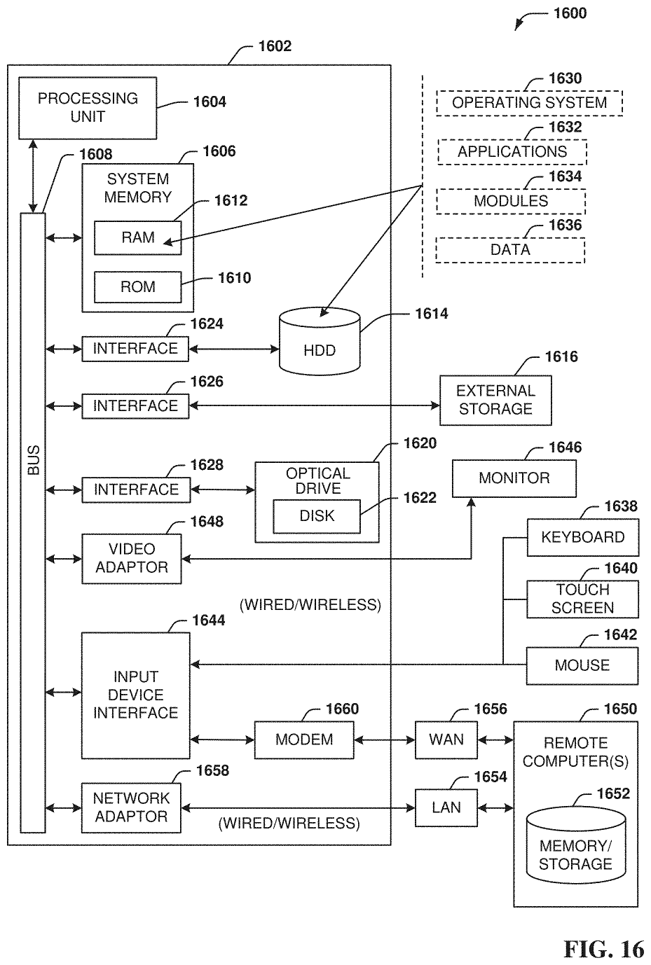

In order to provide additional context for various embodiments described herein, FIG. 16 and the following discussion are intended to provide a brief, general description of a suitable computing environment 1600 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared, and other wireless media.

With reference again to FIG. 16, the example environment 1600 for implementing various embodiments of the aspects described herein includes a computer 1602, the computer 1602 including a processing unit 1604, a system memory 1606 and a system bus 1608. The system bus 1608 couples system components including, but not limited to, the system memory 1606 to the processing unit 1604. The processing unit 1604 can be any of various commercially available processors. Dual microprocessors and other multi-processor architectures can also be employed as the processing unit 1604.

The system bus 1608 can be any of several types of bus structure that can further interconnect to a memory bus (with or without a memory controller), a peripheral bus, and a local bus using any of a variety of commercially available bus architectures. The system memory 1606 includes ROM 1610 and RAM 1612. A basic input/output system (BIOS) can be stored in a non-volatile memory such as ROM, erasable programmable read only memory (EPROM), EEPROM, which BIOS contains the basic routines that help to transfer information between elements within the computer 1602, such as during startup. The RAM 1612 can also include a high-speed RAM such as static RAM for caching data.

The computer 1602 further includes an internal hard disk drive (HDD) 1614 (e.g., EIDE, SATA), one or more external storage devices 1616 (e.g., a magnetic floppy disk drive (FDD) 1616, a memory stick or flash drive reader, a memory card reader, etc.) and an optical disk drive 1620 (e.g., which can read or write from a CD-ROM disc, a DVD, a BD, etc.). While the internal HDD 1614 is illustrated as located within the computer 1602, the internal HDD 1614 can also be configured for external use in a suitable chassis (not shown). Additionally, while not shown in environment 1600, a solid-state drive (SSD) could be used in addition to, or in place of, an HDD 1614. The HDD 1614, external storage device(s) 1616 and optical disk drive 1620 can be connected to the system bus 1608 by an HDD interface 1624, an external storage interface 1626 and an optical drive interface 1628, respectively. The interface 1624 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1602, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1612, including an operating system 1630, one or more application programs 1632, other program modules 1634 and program data 1636. All or portions of the operating system, applications, modules, and/or data can also be cached in the RAM 1612. The systems and methods described herein can be implemented utilizing various commercially available operating systems or combinations of operating systems.

Computer 1602 can optionally comprise emulation technologies. For example, a hypervisor (not shown) or other intermediary can emulate a hardware environment for operating system 1630, and the emulated hardware can optionally be different from the hardware illustrated in FIG. 16. In such an embodiment, operating system 1630 can comprise one virtual machine (VM) of multiple VMs hosted at computer 1602. Furthermore, operating system 1630 can provide runtime environments, such as the Java runtime environment or the .NET framework, for applications 1632. Runtime environments are consistent execution environments that allow applications 1632 to run on any operating system that includes the runtime environment. Similarly, operating system 1630 can support containers, and applications 1632 can be in the form of containers, which are lightweight, standalone, executable packages of software that include, e.g., code, runtime, system tools, system libraries and settings for an application.

Further, computer 1602 can be enable with a security module, such as a trusted processing module (TPM). For instance, with a TPM, boot components hash next in time boot components, and wait for a match of results to secured values, before loading a next boot component. This process can take place at any layer in the code execution stack of computer 1602, e.g., applied at the application execution level or at the operating system (OS) kernel level, thereby enabling security at any level of code execution.

A user can enter commands and information into the computer 1602 through one or more wired/wireless input devices, e.g., a keyboard 1638, a touch screen 1640, and a pointing device, such as a mouse 1642. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1604 through an input device interface 1644 that can be coupled to the system bus 1608, but can be connected by other interfaces, such as a parallel port, an IEEE 1394 serial port, a game port, a USB port, an IR interface, a BLUETOOTH® interface, etc.

A monitor 1646 or other type of display device can be also connected to the system bus 1608 via an interface, such as a video adapter 1648. In addition to the monitor 1646, a computer typically includes other peripheral output devices (not shown), such as speakers, printers, etc.

The computer 1602 can operate in a networked environment using logical connections via wired and/or wireless communications to one or more remote computers, such as a remote computer(s) 1650. The remote computer(s) 1650 can be a workstation, a server computer, a router, a personal computer, portable computer, microprocessor-based entertainment appliance, a peer device or other common network node, and typically includes many or all of the elements described relative to the computer 1602, although, for purposes of brevity, only a memory/storage device 1652 is illustrated. The logical connections depicted include wired/wireless connectivity to a local area network (LAN) 1654 and/or larger networks, e.g., a wide area network (WAN) 1656. Such LAN and WAN networking environments are commonplace in offices and companies, and facilitate enterprise-wide computer networks, such as intranets, all of which can connect to a global communications network, e.g., the Internet.

When used in a LAN networking environment, the computer 1602 can be connected to the local network 1654 through a wired and/or wireless communication network interface or adapter 1658. The adapter 1658 can facilitate wired or wireless communication to the LAN 1654, which can also include a wireless access point (AP) disposed thereon for communicating with the adapter 1658 in a wireless mode.

When used in a WAN networking environment, the computer 1602 can include a modem 1660 or can be connected to a communications server on the WAN 1656 via other means for establishing communications over the WAN 1656, such as by way of the Internet. The modem 1660, which can be internal or external and a wired or wireless device, can be connected to the system bus 1608 via the input device interface 1644. In a networked environment, program modules depicted relative to the computer 1602 or portions thereof, can be stored in the remote memory/storage device 1652. It will be appreciated that the network connections shown are example and other means of establishing a communications link between the computers can be used.

When used in either a LAN or WAN networking environment, the computer 1602 can access cloud storage systems or other network-based storage systems in addition to, or in place of, external storage devices 1616 as described above. Generally, a connection between the computer 1602 and a cloud storage system can be established over a LAN 1654 or WAN 1656 e.g., by the adapter 1658 or modem 1660, respectively. Upon connecting the computer 1602 to an associated cloud storage system, the external storage interface 1626 can, with the aid of the adapter 1658 and/or modem 1660, manage storage provided by the cloud storage system as it would other types of external storage. For instance, the external storage interface 1626 can be configured to provide access to cloud storage sources as if those sources were physically connected to the computer 1602.

The computer 1602 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

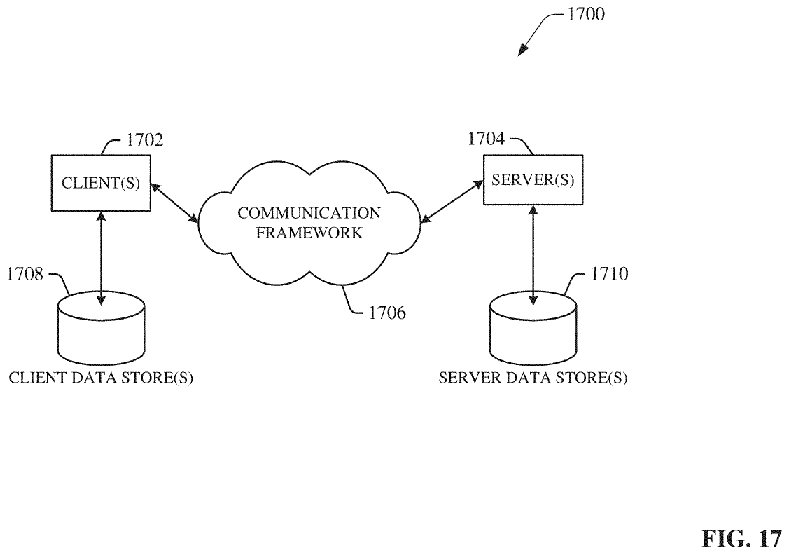

Referring now to FIG. 17, there is illustrated a schematic block diagram of a computing environment 1700 in accordance with this specification. The system 1700 includes one or more client(s) 1702, (e.g., computers, smart phones, tablets, cameras, PDA's). The client(s) 1702 can be hardware and/or software (e.g., threads, processes, computing devices). The client(s) 1702 can house cookie(s) and/or associated contextual information by employing the specification, for example.

The system 1700 also includes one or more server(s) 1704. The server(s) 1704 can also be hardware or hardware in combination with software (e.g., threads, processes, computing devices). The servers 1704 can house threads to perform transformations of media items by employing aspects of this disclosure, for example. One possible communication between a client 1702 and a server 1704 can be in the form of a data packet adapted to be transmitted between two or more computer processes wherein data packets may include coded analyzed headspaces and/or input. The data packet can include a cookie and/or associated contextual information, for example. The system 1700 includes a communication framework 1706 (e.g., a global communication network such as the Internet) that can be employed to facilitate communications between the client(s) 1702 and the server(s) 1704.

Communications can be facilitated via a wired (including optical fiber) and/or wireless technology. The client(s) 1702 are operatively connected to one or more client data store(s) 1708 that can be employed to store information local to the client(s) 1702 (e.g., cookie(s) and/or associated contextual information). Similarly, the server(s) 1704 are operatively connected to one or more server data store(s) 1710 that can be employed to store information local to the servers 1704.

In one exemplary implementation, a client 1702 can transfer an encoded file, (e.g., encoded media item), to server 1704. Server 1704 can store the file, decode the file, or transmit the file to another client 1702. It is noted that a client 1702 can also transfer uncompressed file to a server 1704 and server 1704 can compress the file and/or transform the file in accordance with this disclosure. Likewise, server 1704 can encode information and transmit the information via communication framework 1706 to one or more clients 1702.

The illustrated aspects of the disclosure may also be practiced in distributed computing environments where certain tasks are performed by remote processing devices that are linked through a communications network. In a distributed computing environment, program modules can be located in both local and remote memory storage devices.

The above description includes non-limiting examples of the various embodiments. It is, of course, not possible to describe every conceivable combination of components or methods for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. Fixed location radio access network equipment, comprising:
a processor; and
a memory that stores executable instructions that, when executed by the processor, facilitate performance of operations, comprising:
identifying a group of mobile devices that comprise respective capabilities, collectively usable to establish an alternate radio access network as backup to a primary radio access network enabled via the fixed location radio access network equipment, wherein the fixed location radio access network equipment facilitates individual communicative connections to mobile devices of the group of mobile devices via the primary radio access network, and wherein the alternate radio access network comprises a peer-to-peer mesh network enabled via the group of mobile devices; and
in response an event being determined to have occurred that affects operation of the primary radio access network, activating the alternate radio access network via the group of mobile devices and re-routing communications from being communicated via the fixed location radio access network equipment of the primary radio access network to being communicated via the group of mobile devices of the alternate radio access network.

2. The fixed location radio access network equipment of claim 1, wherein the operations further comprise:
determining a first connection quality associated with a first connection to the peer-to-peer mesh network from a first mobile device, of the group of mobile devices, entering a geographic region associated with the primary radio access network and associated with the alternate radio access network; and
in response to the first connection quality being determined to be greater than a second connection quality associated with a second connection to the peer-to-peer mesh network from a second mobile device, of the group of mobile devices, located in the geographic region, replacing the second mobile device with the first mobile device in the alternate radio access network.

3. The fixed location radio access network equipment of claim 1, wherein each mobile device of the group of mobile devices comprises a unique identifier of unique identifiers verified by the fixed location radio access network equipment using a blockchain communication network configured to authenticate the unique identifiers.

4. The fixed location radio access network equipment of claim 3, wherein the operations further comprise:
in response to verifying a mobile device of the mobile devices, updating trust data associated with the mobile device, wherein the trust data is representative of a probability that the mobile device is a potentially malicious mobile device, and wherein the updating results in a decrease in the probability.

5. The fixed location radio access network equipment of claim 1, wherein the operations further comprise:
generating a data segment comprising padding bits representative of a three-dimensional shape, wherein the three-dimensional shape comprises a unique identifier of the data segment; and
associating the data segment with a mobile device of the mobile devices.

6. The fixed location radio access network equipment of claim 5, wherein the three-dimensional shape comprises a piece of a three-dimensional hologram puzzle, and wherein an authentication comprises the three-dimensional shape being determined to fit the three-dimensional hologram puzzle.

7. The fixed location radio access network equipment of claim 6, wherein the operations further comprise:
in response to determining that the three-dimensional shape fits the three-dimensional hologram puzzle, designating the data segment as an authorized data segment.

8. The fixed location radio access network equipment of claim 1, wherein activating the alternate radio access network comprises activating the alternate radio access network via a communication sent to a manager mobile device, of the group of mobile devices, wherein the manager mobile device manages the peer-to-peer mesh network, and wherein, based on the communication, the manager mobile device facilitates the activating of the peer-to-peer mesh network by sending further communications to other mobile devices of the group of mobile devices other than the manager mobile device.

9. The fixed location radio access network equipment of claim 1, wherein the operations further comprise:
determining that the event has occurred that has affected the operation of the primary radio access network, comprising obtaining information that the event has affected the operation of the primary radio access network by at least a threshold amount according to a defined network performance metric.

10. A non-transitory machine-readable medium, comprising executable instructions that, when executed by a processor, facilitate performance of operations, comprising:
determining a group of nodes that comprise respective capabilities, collectively usable to establish a substitute radio access network as a substitute for a main radio access network enabled via radio access network equipment, wherein the radio access network equipment facilitates individual communicative connections to the nodes of the group of nodes via the main radio access network, and wherein the substitute radio access network comprises a mesh network enabled via the group of nodes; and
in response an incident being determined to have occurred that affects operation of the main radio access network, switching from using the main radio access network to using the substitute radio access network via the group of nodes, the switching comprising re-routing communications from being communicated via the radio access network equipment of the main radio access network to being communicated via the group of nodes of the substitute radio access network.

11. The non-transitory machine-readable medium of claim 10, wherein the operations further comprise:
determining a first estimated amount of time that a node, of the group of nodes, is threshold likely to remain within a geographic region associated with the main radio access network and associated with the substitute radio access network; and
in response to determining that a task, associated with the substitute radio access network, is achievable in the first estimated amount of time, assigning the task to the node.

12. The non-transitory machine-readable medium of claim 11, wherein the task comprises operating the node as an antenna.

13. The non-transitory machine-readable medium of claim 11, wherein the task comprises operating the node as a transmitter.

14. The non-transitory machine-readable medium of claim 11, wherein the task comprises operating the node as a signal processing filter.

15. The non-transitory machine-readable medium of claim 11, wherein the task comprises operating the node as a signal modulator.

16. The non-transitory machine-readable medium of claim 11, wherein the task comprises recurring sub-tasks.

17. The non-transitory machine-readable medium of claim 11, wherein the node is a first node, and wherein the operations further comprise:
determining a second estimated amount of time that a second node, of the group of nodes, is threshold likely to be located within the geographic region, wherein the second estimated amount of time terminates after the first estimated amount of time; and
in response to determining that the task is achievable in the second estimated amount of time, reassigning the task from the first node to the second node.

18. A method, comprising:
generating, by a device comprising a processor, a data segment comprising padding bits and representative of a three-dimensional shape comprising a piece of a three-dimensional hologram puzzle, wherein the three-dimensional shape comprises a unique identifier of the data segment;
associating, by the device, the data segment with a mobile device of a group of mobile devices collectively usable to establish a secondary radio access network as backup to a primary radio access network enabled via fixed location radio access network equipment; and
in response to the three-dimensional shape being determined by the mobile device to fit the three-dimensional hologram puzzle, designating, by the device, the data segment as an authorized data segment.

19. The method of claim 18, wherein the mobile device comprises a chamber comprising a projector and a sensor, and wherein the mobile device determines a quality of a match between shapes of the three-dimensional hologram puzzle according to a matching criterion by projecting the three-dimensional hologram puzzle within the chamber.

20. The method of claim 18, wherein the three-dimensional shape comprises hashed data employable to reconstruct the piece of the three-dimensional hologram puzzle.
